(19) United States
(12) Patent Application Publication
(10) Pub. No.: US 2011/0193686 A1
(43) Pub. Date: Aug. 11, 2011

(54) TAG READER, TAG READER CONTROL METHOD, AND TAG READER CONTROL PROGRAM

(76) Inventors: Hirokazu Takatama, Tokyo (JP); Sawako Mikami, Tokyo (JP)

(21) Appl. No.: 13/121,223

(22) PCT Filed: Oct. 22, 2009
(86) PCT No.: PCT/JP2009/068540

§ 371 Date: Mar. 28, 2011

(30) Foreign Application Priority Data
Oct. 27, 2008 (JP) 2008-275831

(51) Int. Cl. H04Q 5/22

(52) U.S. Cl. 340/10.3

(57) ABSTRACT

There has been a problem that it is impossible to ensure the ability to acquire RFID tag state information and at the same time reduce the power consumption necessary therefore. Provided is a tag reader including a read means, which detects the loss of communication with a tag during communication with the tag, and a control means, which counts the number of times communication with the tag is lost on the basis of the losses detected by the read means and disables execution of a communication process with the tag when the number of losses has reached a predetermined threshold value.

### TECHNICAL FIELD

The present invention relates to a tag reader, a tag reader control method and a tag reader control program.

### BACKGROUND ART

An example of intravenous drug collating apparatus using an IC (Integrated Circuit) tag and or the like is described in patent document 1. The intravenous drug collating device described in the patent document 1 has a reading apparatus which reads the identification codes of intravenous drug and blood transfusion medicine by noncontact technique using an IC tag (it is also generally called a radio integrated circuit tag) for example, communication interface which communicates to an external system, a collating device which collates the direction information for medication obtained by the communication interface and the identification codes of intravenous drug and blood transfusion medicine, and an indicating device which indicates the collation result. This intravenous drug collating apparatus is included in the intravenous drip stand and reads the identification codes of intravenous drug and blood transfusion medicine which are stuck on the intravenous drip by the opportunity that the intravenous drip is hanged on the intravenous drip stand. Then the intravenous drug collating apparatus collates the identification codes of intravenous drug and blood transfusion medicine with “the information of intravenous drip which is prescribed to a patient” obtained from external medical information system and indicates the result of collation whether a combination is correct or wrong to the indication means. Based on the above-mentioned operation, the intravenous drug collating apparatus of the patent document 1 reduces confirmation works in the medication execution and enables improvement of the reliability.

And an example of a radio tag (it is also generally called a radio IC tag) information management apparatus is described in the patent document 2. The radio tag information management apparatus of the patent document 2 has a reader/writer unit which radiates the radio waves through the antenna, a radio wave controlling unit which controls the communication to the radio tag by controlling the reader/writer unit, and an information managing and controlling unit which controls the whole radio tag information management apparatus. This radio tag information management apparatus begins the radiation of the radio wave by receiving the direction of read/write processing to a radio tag and enables to suppress the own power consumption by suspending the radiation of the radio waves when the amount of radio tags which have executed the read/write processing reaches the predetermined total amount of the radio tags which should be process.

And an example of an RFID (Radio Frequency Identification) reader is described in the patent document 3. The RFID reader of the patent document 3 requests a response to each tag (it is also generally called a wireless IC tag) by specifying the identification information and enables to provide useful information for the inventory control and so on of the products by distinguishing that the tags with the identification information is undetected when there is no response.

Moreover, an example of an information providing system using radio tags is described in the patent document 4. The information providing system of the patent document 4 has a radio tag (it is also generally called a radio IC tag) reader, an information providing server, and radio tag DB (Data Base). In this information providing system, an information providing server acquires attribute information corresponding to this ID from the radio tag DB based on the ID (Identification) that the radio tag reader reads from the radio tag. Then, when the number of the radio tags which have the predetermined characteristic information meets the predetermined condition, the radio tag reader transmits the status. Based on the above mentioned operation, the information providing system of the patent document 4 enables to provide useful information obtained by identifying target objects individually.

Moreover, an example of a radio communication terminal is described in the patent document 5. The radio communication terminal of the patent document 5 has a signal level detecting unit, a signal processing unit, a high frequency unit, a controlling unit, a power unit, and a SW (SWITCH) unit. The SW unit suspends power supply to the controlling unit, the signal processing unit and the high frequency unit in the standby. And the SW unit supplies the power to the controlling unit, the signal processing unit and the high frequency unit when the predetermined level of the received signal is detected by the signal lever detecting unit. Based on these operations, the SW unit enables to suppress the power consumption when the processing which should be accomplished is limited.

### The Preceding Technical Document

### [Patent Document]

[Patent document 1] Japanese Patent Application Laid-Open No. 2008-061863

[Patent document 2] Japanese Patent Application Laid-Open No. 2007-115219

[Patent document 3] Japanese Patent Application Laid-Open No. 2005-263480

[Patent document 4] Japanese Patent Application Laid-Open No. 2005-084827

[Patent document 5] Japanese Patent Application Laid-Open No. 2006-005518

### DISCLOSURE OF INVENTION

### Problem Which Invention Tries to Settle

However, in the technologies described in the patent documents mentioned above, as described below, there is a problem that coexistence of acquisition of the status information of an RFID tag and suppression of the power consumption based on this is not enough.

Although the technology of the patent document 1 can improve the reliability of the prior confirmation in prescription implementation to a patient, it cannot acquire the information that the prescription is completed. And the technology of the patent document 1 cannot control the reading apparatus which is not needed to work after the process finished for suppressing its power consumption.

The technology of the patent document 2 can suppress the power consumption when a radio tag does not exist. However, the technology of the patent document 2 comes out by enabling to pass the window gate based on implementing the window gate for the specific area and indicating whether the window gate operation is “enter” or “exit” about existence or non-existence of radio tags in a specific area. In other words, the technology of the patent document 2 cannot detect the status that the radio tag is undetected by the reader/writer unit (that is the status in that the radio tag and the object articles stuck the radio tag for management become outside the object of processing physically).

The technologies of the patent document 3 and 4 have no consideration about the suppression of power consumption, and cannot suppress the power consumption based on the status information of an RFID tag.

The technology of the patent document 5 is that a radio communication terminal which corresponds to a radio tag suppresses the power consumption based on its own state. Therefore, the technology of the patent document 5 is not the technology which can solve the subject achieving the coexistence of acquisition of the RFID tag state information and suppression of the power consumption based on this.

The object of the present invention is to provide a tag reader which settles the problem mentioned above, a tag reader control method and a tag reader control program.

### Means for Settling a Problem

A tag reader of the present invention comprising reading means for detecting undetection of said tag in the communication processing with said tag, and control means for disabling execution of said communication processing with said tag when undetection number of said tags is counted and said undetection number reaches predetermined undetection threshold value based on detection of undetection using said reading means.

A tag reader control method, characterized by comprising: detecting undetection of said tag in communication processing with said tag, counting undetection of said tags, and disabling execution said communication processing with said tag when said undetection number reaches predetermined undetection threshold value based on said undetection.

A tag reader control program, characterized by making a computer work as: a process for detecting undetection of said tag in communication processing with said tag, a process for counting undetection number of said tag, and a process for disabling execution said communication processing with said tag when said undetection number reaches predetermined undetection threshold value based on detection of said undetection.

### The Effect of the Invention

Base on the present invention, it is enabling to coexist acquisition of the status information of an RFID tag with suppression of the power consumption.

### BRIEF DESCRIPTION OF THE DRAWINGS

FIG. 1 is a block diagram showing the construction of the RFID reader of first, second and third exemplary embodiment of the present invention.

FIG. 2 is a block diagram showing the construction of the reading means of first, second and third exemplary embodiment of the present invention.

FIG. 3 is a block diagram showing the construction of the control means of first, second and third exemplary embodiment of the present invention.

FIG. 4 is a figure showing the structure of the tag table of first, second and third exemplary embodiment of the present invention.

FIG. 5 is a flowchart showing an operation of the first exemplary embodiment of the present invention.

FIG. 6 is a block diagram showing the construction of the fourth exemplary embodiment of the present invention.

FIG. 7 is a block diagram showing the construction of the control means of the fourth exemplary embodiment of the present invention.

FIG. 8 is a block diagram showing the construction of the collation means of the fourth exemplary embodiment of the present invention.

FIG. 9 is a figure showing the structure of the managed identification information table of the fourth exemplary embodiment of the present invention.

FIG. 10 is a figure showing the structure of the detection identification information table of the fourth exemplary embodiment of the present invention.

FIG. 11 is a flowchart showing an operation of the fourth exemplary embodiment of the present invention.

FIG. 12 is a flowchart showing an operation of the fourth exemplary embodiment of the present invention.

FIG. 13 is a block diagram showing the construction of the fifth exemplary embodiment of the present invention.

FIG. 14 is a block diagram showing the construction of the sixth exemplary embodiment of the present invention.

FIG. 15 is a block diagram showing the construction of the seventh exemplary embodiment of the present invention.

FIG. 16 is a flowchart showing a part of the operation of the seventh exemplary embodiment of the present invention.

FIG. 17 is a block diagram showing the construction of the eighth exemplary embodiment of the present invention.

FIG. 18 is a flowchart showing a part of the operation of the eighth exemplary embodiment of the present invention.

FIG. 19 is a block diagram showing the construction of the ninth exemplary embodiment of the present invention.

FIG. 20 is a block diagram showing the construction of the RFID reader of the ninth exemplary embodiment of the present invention.

### DESCRIPTION OF A CODE

100 RFID reader.

110 A reading means.

111 A tag table.

111 A reading means.

112 Identification information.

113 The responce state.

115 A reading interval holding section.

116 Reading interval information.

117 Timer.

118 Count-up value.

120 Control means.

121 Undetection number counter.

122 Undetection number.

123 Undetection threshold value holding section.

124 Undetection threshold value.

125 Reading operation status holding section.

126 Reading operation status.

200 RFID reader.

200 RFID reader.

201 RFID reader.

203 RFID reader.

203 RFID reader.

210 Reading means.

250 Timer.

260 Closeness detection means.

270 Closeness identification means.

280 Display means.

300 RFID reader.

310 Reading means.

320 Control means.

340 Collation means.

341 Managed identification information table.

341 Managed identification information table.

342 Managed identification information.

343 Detection identification information table.

344 Detection identification information.

400 Intravenous drip

410 RFID tag.

411 Identification information.

420 Intravenous drip stand.

430 Medical information system.

440 Beacon.

450 Wireless LAN antenna.

460 Medical staff.

470 Wireless LAN tag.

500 Intravenous drip.

510 RFID tag.

### THE BEST FORM FOR CARRYING OUT THE INVENTION

Next, the first exemplary embodiment of the present invention will be described in detail with reference to drawings.

First, the basic construction of this exemplary embodiment will be described.

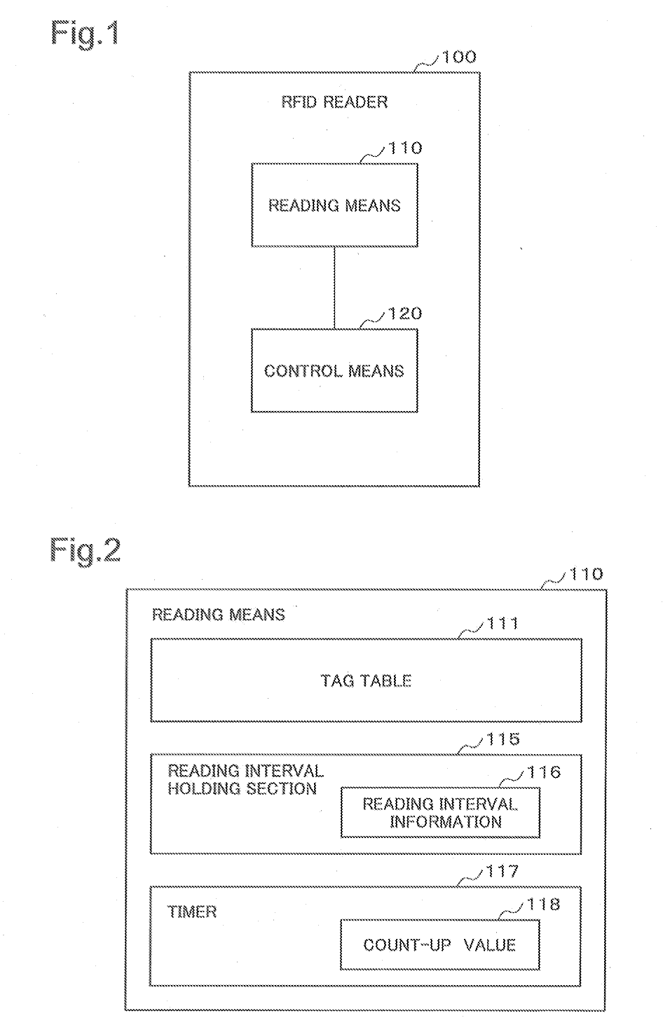

Referring to FIG. 1, an RFID reader 100 of the first exemplary embodiment of the present invention includes a reading means 110 and a control means 120. Further, the RFID reader may be called a tag reader.

The reading means 110 detects undetection of the RFID tag in communication processing with the RFID tag and outputs the undetection notification to the control means 120 based on this. Further, the RFID tag may be called a tag.

The control means 120 counts the number of undetection of the RFID tag based on undetection notification and disables an execution of communication processing using the reading means 110 when the number of undetection reaches the undetection threshold value. Further, the undetection threshold value may be held in advance in the control means 120 or it may be given from outside using a means which is not illustrated.

Next, an example of the detailed composition of this exemplary embodiment will be described.

Referring to FIG. 2, the reading means 110 includes a tag table 111, a reading interval holding section 115 and a timer 117.

The tag table 111 holds identification information 112 of RFID tag which is the other party of communication for the reading means 110 and the response state 113 which is based on whether the RFID tag responds by the identification information or not.

A reading interval holds section 115 holds the reading interval information 116.

The timer 117 sets a count-up value 118 to 0 whenever it be reset and increases the count-up value 118 one by one every a certain fixed time interval (for example, 1 second).

The reading means 110 stores the reading interval information 116 included in the reading start instruction to the reading interval holds section 115 by receiving the reading start instruction from outside and starts the periodic communication processing with RFID tag (not illustrated) based on this reading interval information 116 and the count-up value 118 which the timer 117 counts.

Then, the reading means 110 creates the undetection notification which indicates “undetection” and outputs it to the control means 120 when it detects the undetection of an RFID tag in the communication processing.

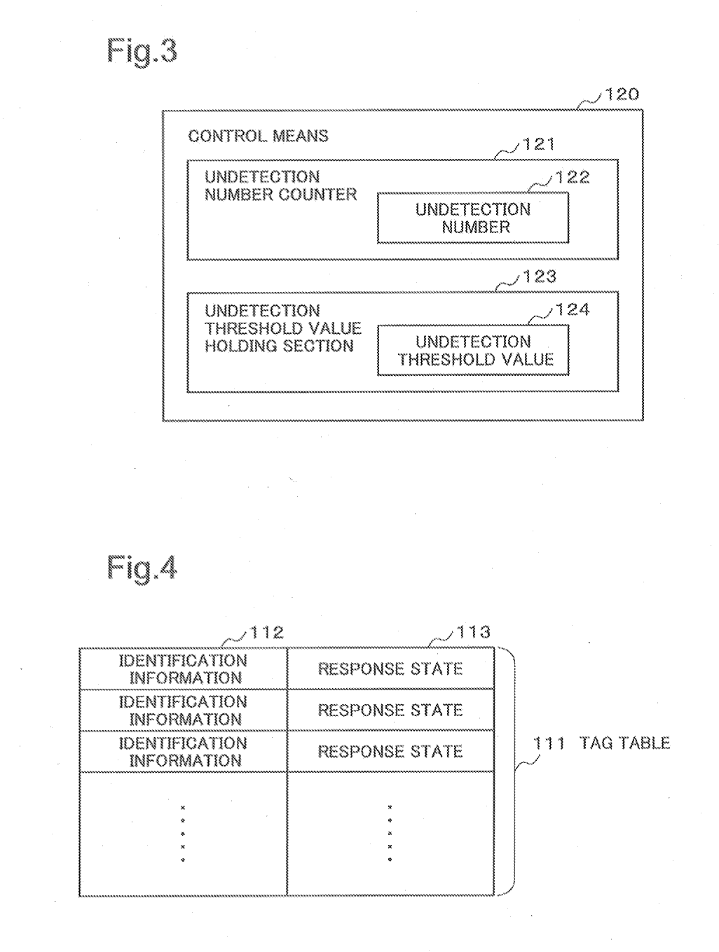

Referring to FIG. 3, the control means 120 includes an undetection number counter 121 and an undetection threshold value holding section 123.

The undetection number counter 121 holds an undetection number 122. The undetection threshold value holding section 123 holds an undetection threshold value 124. The undetection threshold value 124 may be held in an undetection threshold value holding section 123 in advance or it may be input from an operator or an external system using a means which is not illustrated.

The control means 120 sets the count value of the undetection number counter 121 to be “0” and outputs a reading start instruction including the reading interval information 116 to the reading means 110 when an opportunity of a reading processing start occurs. The opportunity of reading process start may be the instructions from an operator using a means which is not illustrated or may be the instructions from the external systems (for example, the undetection threshold value 124 transmitted from the external system is received and the reception of this undetection threshold value 124 is assumed the opportunity).

And, the control means 120 add “1” to the undetection number 122 which is a count value of the undetection number counter 121 whenever it severally inputs undetection notification from the reading means 110. Moreover, the control means 120 disables an execution of communication processing using the reading means 120 when the undetection number 122 reaches the undetection threshold value 124 stored in an undetection threshold value holding section 123.

Next, the detailed operation of this exemplary embodiment will be described with reference to FIGS. 1 to 5.

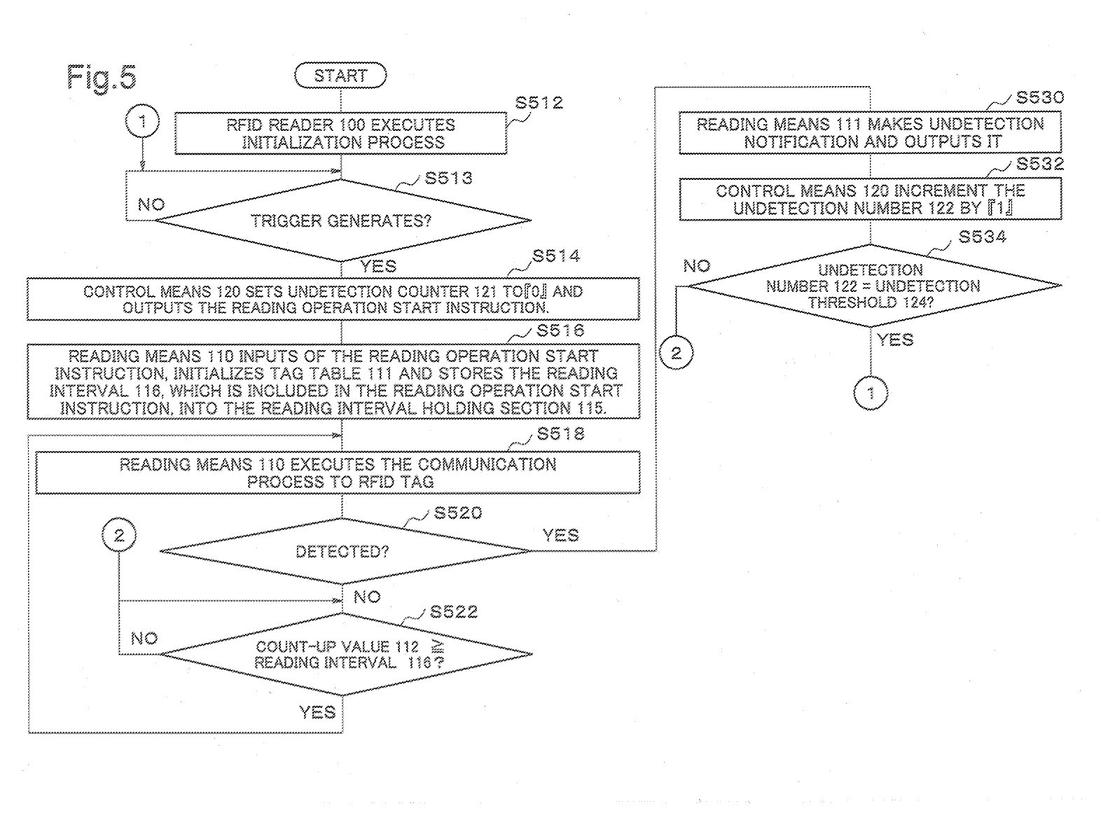

FIG. 5 is a flowchart showing an operation of this exemplary embodiment.

First, RFID reader 100 starts an operation by the opportunity that the power is provided for example and executes its own initialization process (Step S512). Further, for example, the RFID reader 100 may start an operation by the opportunity of receiving the initialization instruction from an operator or an external system using a means which is not illustrated. The initialization process which executes the preparation for the beginning of the functional operation by the RFID reader 100 includes a diagnosis, a load of program and pre-processing for the work field. Because the initialization process differs according with the method of achieving the RFID reader 100 and is a well-known technology, a concrete explanation is omitted.

Next, the RFID reader 100 waits an occurrence of the opportunity of reading process start (Step S513), returns to the process of Step S513 when the opportunity does not occur (NO in Step S513), and proceeds to the process of Step S514 when the opportunity occurs (YES in Step S513).

When the occurrence of opportunity is detected in Step S513, the control means 120 sets the count value of the undetection number counter 121 to “0” and outputs the reading start instruction including the reading interval information 116 to the reading means 110 (Step S514). The reading interval information 116 is set in the control means 120 in advance, which is the arbitrary value such as several minutes or several hours, for example. Further, the reading interval information 116 may be input from an operator or an external system using a means which is not illustrated.

The reading means 110 inputs the reading start instructions from the control means 120, initializes the tag table 111, and stores the reading interval information 116 included in the reading starting instructions in a reading interval holding section 115 (Step S516). In the tag table 111, based on the initial configuration, all response state 113 are set to “Not received”, as well as the identification information of all RFID tags are set to “Not available” (“0” clear, for example).

Successively, the reading means 110 executes a communication processing to RFID tag (Step S518). The communication processing is a processing which sends the command which requests the identification information to a RFID tag from the reading means 110, sends the response including the identification information to the reading means 110 from the RFID tag in responding to this command, and the reading means 110 detects the undetection of a RFID tag by analyzing this received response. Details of this detection processing will he described later.

When the undetection of the RFID tag is not detected in Step S518 (No in Step S520), the reading means 110 proceeds to Step S522. In Step S522, the reading means 111 compares the reading interval information 116 and the count-up value 118. When the count-up value 118 is less than the value that the reading interval information 116 indicates (No in Step S522), the reading means 110 returns to the processing of Step S522. When the count-up value 118 is more than and equal the value that the reading interval information 116 indicates (Yes in Step S522), the reading means 110 returns to the processing of Step S518. That is, unless undetection of RFID tag is detected in Step S520, the processing of Step S518 is executed at every time which is specified by the reading interval information 116.

And when undetection of an RFID tag is detected in Step S518 (YES in Step S520), the reading means 110 creates undetection notification corresponding to an RFID tag whose undetection is detected in Step S518 and outputs these undetection notifications to the control means 120 (Step S530).

The control means 120 adds “1” to the undetection number 122 which is the count value of the undetection number counter 121 in responding to inputting the undetection notification (Step S532).

When the undetection number 122 becomes equal to the undetection threshold value 124 which the undetection threshold value holding section 123 holds as a result of the addition in Step S532 (Yes in Step S534), the RFID reader 100 returns to the processing of Step S513. Accordingly, unless the opportunity of reading start occurs once again, the RFID'reader 100 does not proceed to Step S518, and the reading means 110 does not execute the communication processing to the RFID tag. Consequently, the reading means 110 does not radiate radio waves for the communication.

And when the undetection number 122 does not equal the undetection threshold value 124 held in the undetection threshold value holding section 123 (No in Step S534), the RFID reader 100 returns to the processing of Step S522.

Further, the reading means 110 may communicate with an RFID tag using the electromagnetic waves other than radio waves (such as light) and not executing communication processing means no radiation of the electromagnetic waves used for the communication processing namely.

Next, the one example of the operation that the reading means 110 analyzes the received response and detects the undetection of an RFID tag in Step S518 will be described.

First, the response state 113, which is the information indicating the state of the RFID tag held in the tag table 111, will be described. The response state 113 takes any value in “Not Received”, “Detection”, “Match”, and “Undetection”. “Not Received” is the initial state which is set in Step S516 and the identification information 112 responding to it is “Not available” too. “Detection” indicates the identification information of the RFID tag with the response for the first time, “Match” indicates occurrence of response of the identification information again from the RFID tag with the response at least once, and “Undetection” indicates no response of the identification information from the RFID tag with the response at least once.

As mentioned above, the reading means 110 sends the command that requests the identification information to an RFID tag and receives the response for it from the each RFID tag. Then the reading means 110 retrieves the identification information 113 of the tag table 111 with the identification information included in these responses as a key except the response whose response state 113 is “Not Received”. When there is no match, then, the reading means 110 registers the identification information included in the response from the RFID tag in the tag table 111 and sets the corresponding response state 113 to “Detection”. When there is match, the reading means 110 sets the corresponding response state 113 to “Match”. And the reading means 110 sets tentatively all “Detection” and “Match” among the response state 113 which are recorded in the tag table 111 to “Undetection” at first in every communication processing (Step S518).

Based on the operations above mentioned, after inputting the reading start instruction, the response state 113 of undetected RFID tag, that is the RFID tag which responded once and has not responded after it, have kept “Undetection” and the reading means 110 detects the undetection of RFID tag.

Further, when the undetection notification is outputted to the control means 120, the reading means 110 sets the corresponding response state 113 to “Undetection” and prevents from outputting the undetection of the same RFID tag more than once.

The effect in this exemplary embodiment mentioned above is the point to enable to execute the coexistence of the acquisition of response state 113 of an RFID tag and the suppression of the power consumption based on this. The reason is because the tag reader of this exemplary embodiment detects the undetection of RFID tag in the communication processing with RFID tag, counts the undetection number 122 of RFID tags based on the detection of the undetection, and suspends the communication processing with RFID tag when the undetection number 122 reaches the predetermined the undetection threshold value 124.

Next, the second exemplary embodiment of the present invention will be described in detail with reference to a drawing.

The construction of the second exemplary embodiment of the present invention is same as the first exemplary embodiment.

A difference from the first exemplary embodiment will be described about the operation of the second exemplary embodiment of the present invention.

In communication processing, the reading means 110 outputs the detection notification to the control means 120. That is, the reading means 110 detects the detection of RFID tag based on that the response state 113 of the tag table 111 is “Detection”. In case of detecting the detection of RFID tag, the reading means 110 creates the detection notification for RFID tag which it detects the detection and outputs this detection notification to the control means 120.

The control means 120 subtract “1” from the undetection number 122 which is the count value of the undetection number counter 121 if the undetection number 122 which is the count value of the undetection number counter 121 is not “0” based on the input of the detection notification.

The effect in this exemplary embodiment mentioned above is the point to enable to execute the coexistence of the acquisition of response state 113 in an RFID tag and the suppression of the power consumption based on this even in the environment that the RFID reader 100 and the RFID tag temporally are in a condition not to be able to communicate each other. The reason is because the tag reader of this exemplary embodiment detects the undetection and the detection of RFID tag in the communication processing, counts the undetection number 122 of RFID tags based on this detection of the undetection and this detection of the detection, and suspends the communication processing with RFID tag when the undetection number 122 reaches the predetermined the undetection threshold value 124.

Next, the third exemplary embodiment of the present invention will be described in detail with reference to a drawing.

The construction of the third exemplary embodiment of the present invention is same as the first exemplary embodiment.

A difference from the first exemplary embodiment will be described about the operation of the third exemplary embodiment of the present invention.

In communication processing, the reading means 110 adds the identification information of the corresponding RFID tag to the undetection notification, and outputs the undetection notification to the control means 120.

The control means 120 adds “1” to the undetection number 122 which is the count number of the undetection number counter 121 when the identification information of the RFID tag included in the undetection notification does not match with any identification information included in the inputted undetection notifications before.

An example of a concrete realization method is indicated. The control means 120 stores the identification information of RFID tag included in the undetection notification, next, when it inputs the undetection notification, collates the identification information of the RFID tag included in this with the stored identification information of the RFID tag, and add “1” to the undetection number 122 which is the count value of the undetection number counter 121 if there is no match. Further, the control means 120 clears the stored identification information of the RFID tag at the timing of outputting the reading start instructions to the reading means 110.

The effect in this exemplary embodiment mentioned above is the point to enable to execute the coexistence of the acquisition of response state 113 of the RFID tag and the suppression of the power consumption based on this, with high reliability. The reason is because the tag reader of this exemplary embodiment avoids the duplicated counting of the same identification information that is the same RFID undetection by referring to the identification information of the RFID tag in the counting of the undetection number 122.

Next, the fourth exemplary embodiment of the present invention will be described in detail with reference to a drawing.

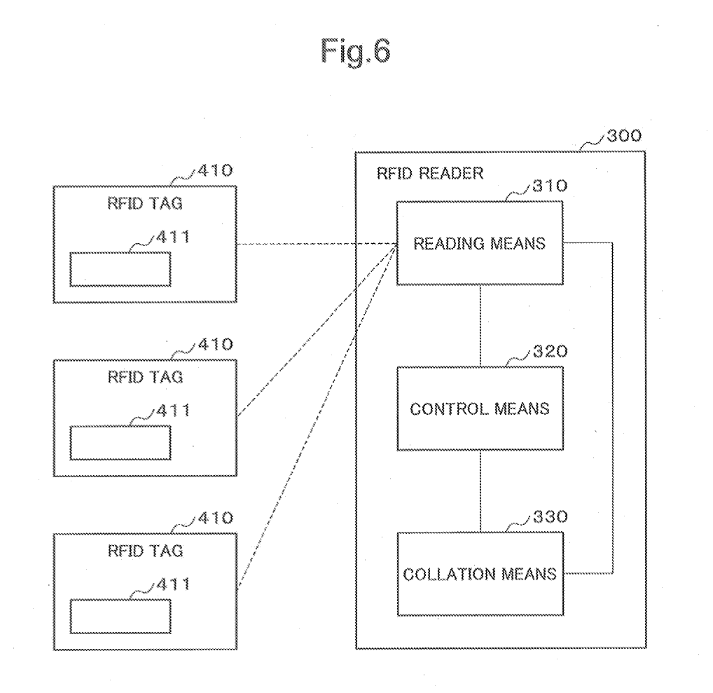

Referring to FIG. 6, the fourth exemplary embodiment of the present invention is constructed with an RFID reader 300 and RFID tags 410. The RFID reader 300 includes a reading means 310, a control means 320 and a collation means 340.

The RFID tag 410 is a managed RFID tag and includes an identification information 411.

The reading means 310 includes the tag table 111, the reading interval holding section 115 and the timer 117 as same as the reading means 110 in the first exemplary embodiment shown in FIG. 2.

The reading means 310 stores the reading interval information 116 which is specified with including in the reading start instruction in the reading interval holding section 115 when the reading start directions are inputted. And the reading means 310 starts the periodic communication processing in order to detect the detection and undetection of the RFID tag (including the RFID tag 410 and other tags which are not illustrated) based on the count-up value 118 counted by the timer 117 and this reading interval information 116. Then when the detection and undetection of RFID tags are detected, the reading means 310 outputs them to the collation means 340. This notification includes the indication of “Detection” or “Undetection” and the corresponding identification information (the identification information 411 or identification information of the other RFID tag which are not illustrated) of the RFID tag.

And the reading means 310 completes the communication processing for detecting the detection and undetection of the RFID tag when the instruction for stopping is inputted.

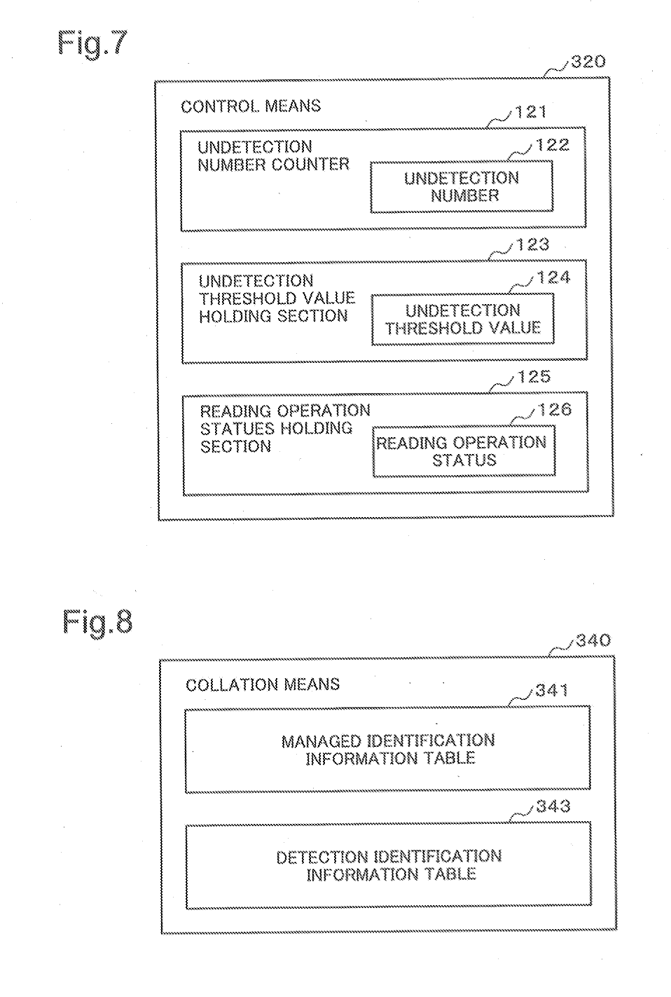

Referring to FIG. 7, the control means 320 includes the undetection number counter 121, the undetection threshold value holding section 123, and a reading operation status holding section 125.

The control means 320, when the undetection threshold value 124 is inputted from the collation means 340, stores this in the undetection threshold value holding section 123.

And the control means 320, when the predetermined opportunity (for example, the notification of the undetection threshold value 124 from the collation means 340) occurs, sets the count value of the undetection number counter 121 to “0”, outputs the reading start instruction including the read interval information 116 to the reading means 310, and sets a reading operation status 126 held in the reading operation status holding section 125 to “Under Execution”.

And the control means 320 adds “1” to the undetection number 122 which is the count value of the undetection number counter 121 based on the inputted undetection notification. Then the control means 320 outputs the stopping instruction to the reading means 310 and sets the reading operation status 126 held in the reading operation status holding section 125 to “Under Suspension” when the undetection number 122 reaches the undetection threshold value 124 stored in the undetection threshold value holding section 123.

Referring to FIG. 8, the collation means 340 includes a managed identification information table 341 and a detection identification information table 343.

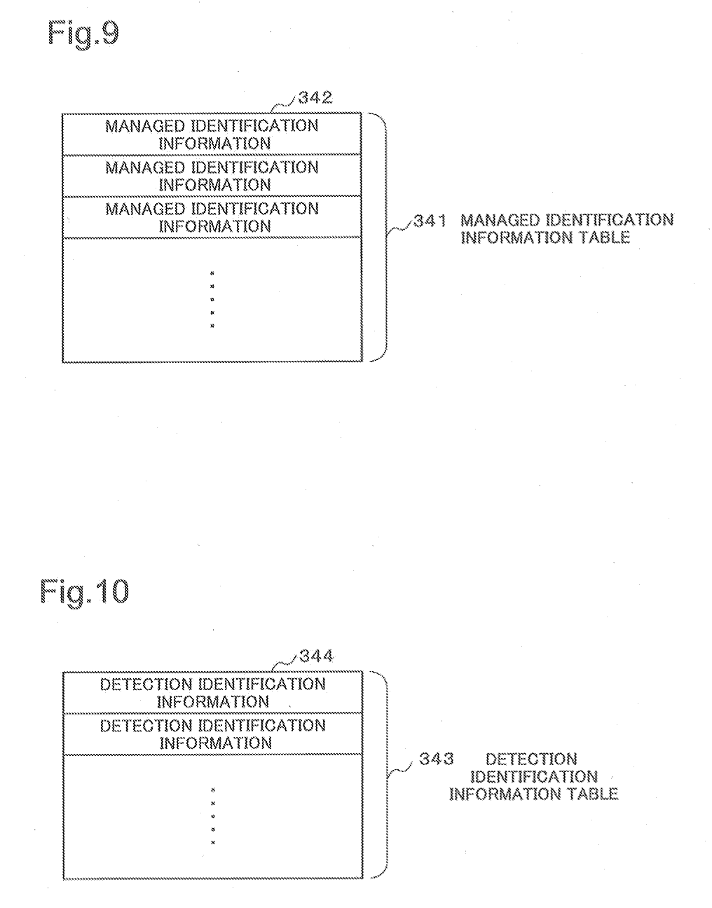

The collation means 340 receives identification information 342 (called the managed identification information hereafter) of the RFID tag 410 sent from the external system which is not illustrated through the network which is not illustrated and stores it in the managed identification information table 341 (referring to FIG. 9). Further, the managed identification information 342 may he fixedly held in the collation means 340 or may read the managed identification information 342 from the RFID tag 410 via the reading means 310 and learns.

And the collation means 340 outputs the number of the managed identification information 342 as the undetection threshold value 124 to the control means 320.

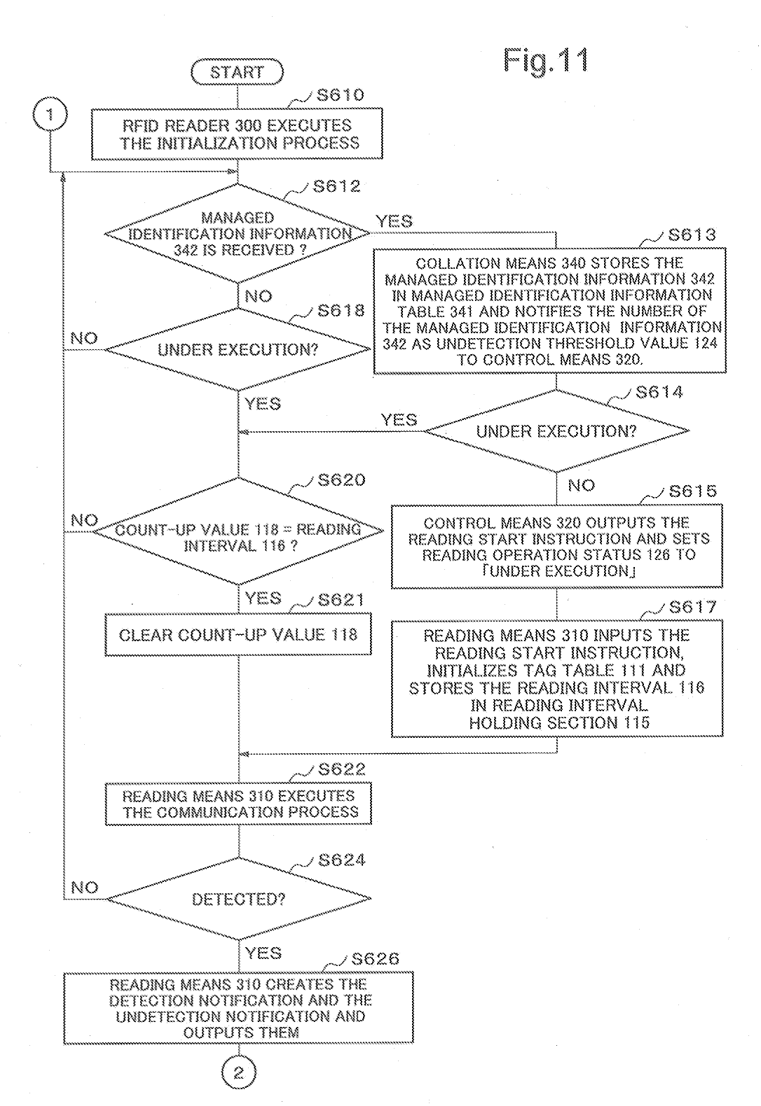

And the collation means 340, when the detection notification of the RFID tag is inputted from the reading means 310, collates whether the identification information included in this is the managed identification information 342 or not in referring to the managed identification information table 341. The collation means 340, when the identification information is the managed identification information 342, adds it to the detection identification information table 343 (referring to FIG. 10) as a detection identification information 344.

And the collation means 340, when the undetection notification of the RFID tag is inputted from the reading means 310, collates whether the identification information included in this is the detection identification information 344 or not in referring to the detection identification information table 343. The collation means 340, when the identification information is the detection identification information 344, deletes this from the detection identification information table 343 and outputs the undetection notification of the RFID tag which is inputted from the reading means 310 to the control means 320.

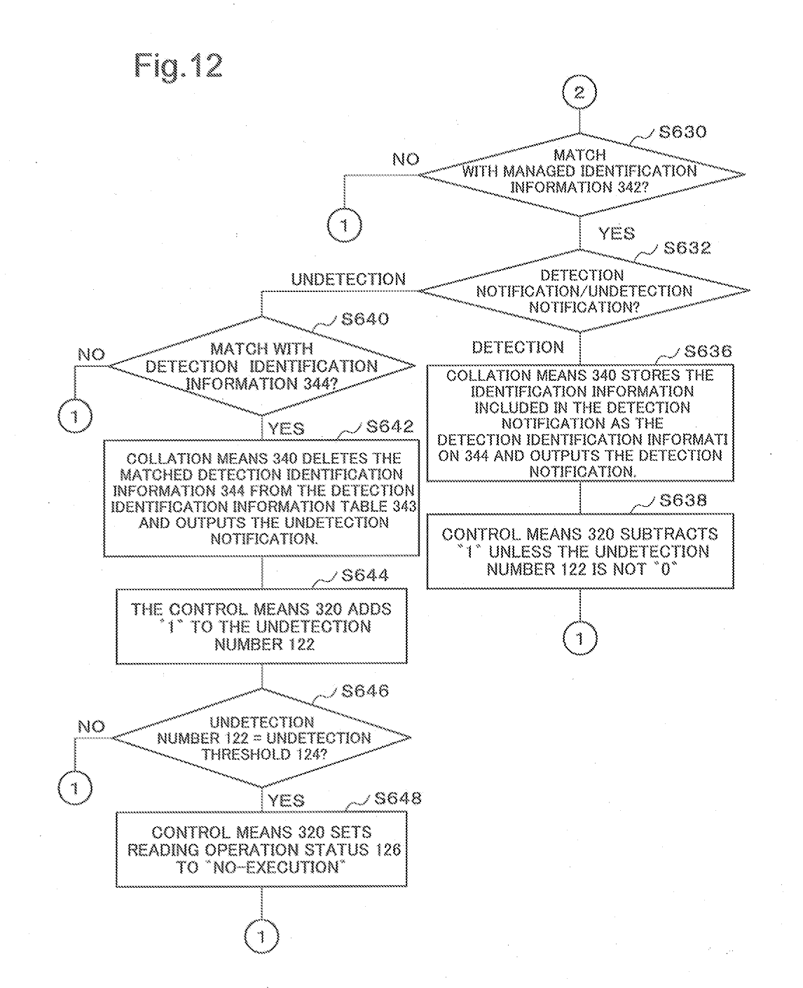

Next, the operation of this exemplary embodiment will be described with reference to FIGS. 6 to 12.

FIG. 11 is a flowchart showing the operation of this exemplary embodiment.

First, the RFID reader 300 begins an operation by turning on the power and executes the own initialization process (Step S610).

Next, the collation means 340 confirms whether the managed identification information 342 has been received or not (Step S612). In the case of receiving (YES in Step S612), the collation means 340 stores the managed identification information 342 which is received in the managed identification information table 341 and notifies the number of the managed identification information 342 as the undetection threshold value 124 to the control means 320 (Step S613). In the case of not receiving (NO in Step S612), the collation means 340 proceeds to the processing of Step S618.

The control means 320 which has received the notification of the undetection threshold value 124 confirms whether the reading operation status 126 held in the reading operation status holding section 125 indicates “Under Execution” (Step S614). When “Under Execution” is indicated (YES in Step S614), the control means 320 proceeds to the processing of Step S620. And when “Under Execution” is not indicated (NO in Step S614), the control means 320 outputs the reading start instructions to the reading means 310 and sets the reading operation status 126 held in the reading operation status holding section 125 to “Under Execution” (Step S615).

Successively, the reading means 310 inputs the reading start instructions from the control means 320, initializes the tag table 111, stores the reading interval information 116 included in the reading start instructions into the reading interval holding section 115 (Step S617), and proceeds to the processing of Step S622.

On the other hand, in the case of NO in Step S612, the control means 320 confirms whether the reading operation status 126 held in the reading operation status holding section 125 indicates “Under Execution” or not (Step S618). When “Under Execution” is not indicated (NO in Step S618), the control means 320 returns to the processing of Step S612. When “Under Execution” is indicated (YES in Step S618), the control means 320 proceeds to processing of Step S620.

In Step S620, the reading means 310 confirms whether the count-up value 118 that the timer 117 counts reaches the value that the reading interval information 116 indicates or not (Step S620). When it does not reach the value which the reading interval information 116 indicates (NO in Step S620), the reading means 310 returns to the processing of Step S612. When it reaches the value which the reading interval information 116 indicates (YES in Step S620), the reading means 310 clears the count-up value 118 (Step S621).

Next, in Step S622, the reading means 310 executes the communication processing (Step S622). When the detection or undetection of the RFID tag is detected (YES in Step S624), the reading means 310 creates the detection notification and the undetection notification corresponding to the RFID tag which detects the detection and the undetection in Step S622 respectively and outputs these detection notification and undetection notification to the collation means 340 (Step S626). And when both of the detection and the undetection of the RFID tag are not detected (NO in Step S624), the reading means 310 returns to the processing of Step S612.

Next, the collation means 340 which inputs the detection and undetection notifications of RFID tag confirms whether the identification information of the RFID tag included in these notifications matches with any one of the managed identification information 342 stored in the managed identification information table 341 or not (Step S630). When it does not match (NO in Step S630), the collation means 340 returns to the processing of Step S612. When it matches, the collation means 340 confirms which the notification is the detection notification or the undetection notification or not (Step S632).

When it is the detection notification (it is the detection in Step S632), the collation means 340 stores the identification information of the RFID tag included in the detection notification into the detection identification information table 343 as the detection identification information 344, and outputs the detection notification to the control means 320 (Step S636).

Successively, unless the undetection number 122 which is the count value of the undetection number counter 121 is not “0”, the control means 320 which inputs the detection notification subtracts “1” from the undetection number 122 which is the count value of the undetection number counter 121 (Step S638) and returns to the processing of Step S612.

And when it is the undetection notification (Undetection in Step S632), the collation means 340 confirms whether the identification information of the RFID tag included in the undetection notification matches with any one of the detection identification information 344 stored in the detection identification information table 343 or not (Step S640). When anyone of the detection identification information 344 is not matched (NO in Step S640), the collation means 340 returns to the processing of Step S612.

And when either of the detection identification information 344 is matched (YES in Step S640), the collation means 340 deletes the detection identification information 344 which matches from the detection identification information table 343 and outputs the undetection notification of it to the control means 320 (Step S642).

Successively, the control means 320 which inputs the undetection notification adds “1” to the undetection number 122 which is the count value of the undetection number counter 121 (Step S644).

Next, the control means 320 confirms whether the undetection number 122 which is the count value of the undetection counter 121 equals to the undetection threshold value 124 held in the undetection threshold value holding section 123 or not (Step S646). When it is not equal (NO in Step S646), the control means 320 returns to the processing of Step S612. When it is equal (YES in Step S646), the control means 320 sets the reading operation status 126 held in the reading operation status holding section 125 to “No Execution” (Step S648) and returns to the processing of Step S612.

The effect in this exemplary embodiment mentioned above is the point to enable to execute the coexistence of the acquisition of the status information of the RFID tag and the suppression of the power consumption based on this with the higher precision. The reason is because the tag reader of this exemplary embodiment detects the detection and undetection of the RFID tag 410 based on the managed identification information 342.

Next, the fifth exemplary embodiment of the present invention will be described in detail with reference to a drawing.

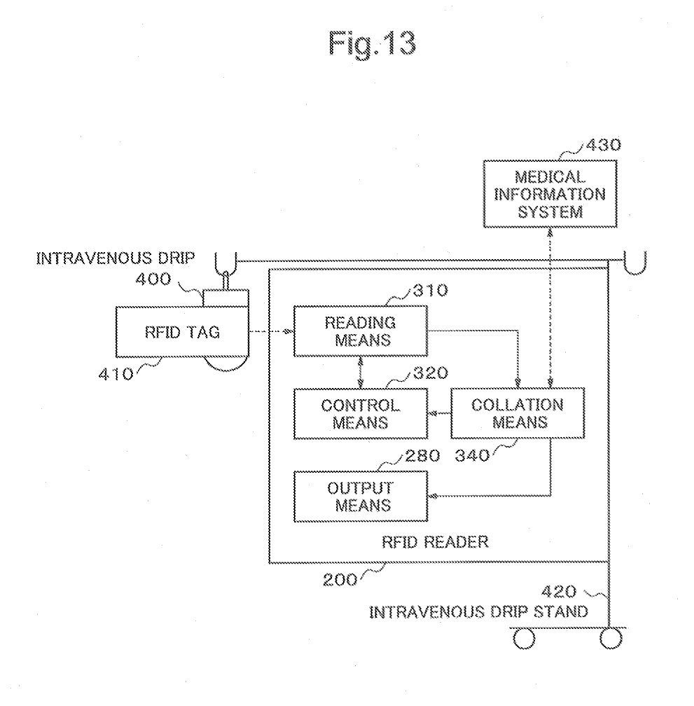

Referring to FIG. 13, the fifth exemplary embodiment of the present invention is comprised an intravenous drip stand 420, an RFID reader 200 installed in the intravenous drip stand 420, an intravenous drip 400, the RFID tag 410 stuck on the intravenous drip 400, and a medical information system 430. The RFID reader 200 includes the reading means 310, the control means 320, the collation means 340, and the output means 280.

Further, in the following description, the part of the description is omitted about the same construction and operation as the fourth exemplary embodiment.

The RFID tag 410 is a managed RFID tag and has the managed identification information 342. The medical information system 430 connects the collation means 340 of the RFID reader 200 via a wireless LAN. The medical information system 430 sends the identification information 411 of the RFID tag 410 which is stuck on the respective intravenous drip 400 prescribed to a certain patient as the managed identification information 342 to the RFID reader 200 which the patient uses.

In a concrete example, the prescription of the intravenous drip 400 is determined for a patient, a medical staff makes the RFID tag 410 to stick on an intravenous drip 400 and inputs the identification information 411 of the RFID tag 410 corresponding to the prescription to the medical information system 430. Based on these input, the medical information system 430 sends the identification information 411 of the RFID tag 410 on the intravenous drip 400 as the managed identification information 342 to the RFID reader 200 which the patient uses.

The RFID reader 200 detects the detection of the RFID tag 410 with the condition which the intravenous drip 400 is within the predetermined distance (for example, the distance in the case that the intravenous drip 400 is applied to the intravenous drip stand 420 or the minimum distance between the intravenous drip stand 420, and so on) from the intravenous drip stand 420, and detects the undetection of the RFID tag 410 when the intravenous drip 400 is separated from the intravenous drip stand 420 beyond the predetermined distance by the communication processing. In a concrete example, when a medical staff applies the intravenous drip 400 to the intravenous drip stand 420 in order to implement the intravenous drip 400 prescribed to a patient, the RFID reader 200 installed in the intravenous drip stand 420 detects the detection of the RFID tag 410 stuck on the intravenous drip 400. And when implementation of the intravenous drip 400 completes and the medical staff removes the intravenous drip 400 from the intravenous drip stand 420, the RFID reader 200 detects the undetection of the RFID tag 410 stuck on the intravenous drip 400.

The output means 280 indicates the warning when the identification information of the RFID which has been detected is not the managed identification information 342. In an concrete example, when the intravenous drip 400 is applied to the intravenous drip stand 420 and the RFID tag identification information whose detection the RFID reader 200 have detected does not match with any managed identification information 342 which is held in the managed identification information table 341, that is, it is not the RFID tag which is stuck on the intravenous drip 400 prescribed to the patient who uses the RFID reader 200, the output means 280 indicates the warning.

Further, the RFID reader 200 may be comprised as an RFID reader 200 for each patient without installing it in the intravenous drip stand 420. In this case, for example, when a stick for applying the intravenous drip 400 is hung from the ceiling of the bedside of the patient, the RFID reader 200 is arranged in the bedside. Then the reading means 310 may detect the detection of the RFID tag 410 which is stuck on the intravenous drip 400 when the intravenous drip 400 is applied to the stick, and the reading means 310 may detect the undetection of the RFID tag 410 which is stuck on the intravenous drip 400 when the intravenous drip 400 is removed from the stick.

The first effect in this exemplary embodiment mentioned above is the point to enable to execute the coexistence of the certain implementation of the intravenous drip 400 prescribed to a patient and the suppression of the power consumption based on the result. The reason is because the medical information system of this exemplary embodiment sets the identification information 411 of the RFID tag 410 which is stuck on the intravenous drip 400 prescribed to the patient as the managed identification information 342 to the RFID reader 200 according to a certain patient.

The second effect in this exemplary embodiment mentioned above is the point to enable to execute the prevention of the improper implementation of the intravenous drip to a patient. The reason is because the RFID reader of this exemplary embodiment indicates the warning when the identification information 411 of RFID tag whose detection is detected does not match with the managed identification information 342.

Next, the sixth exemplary embodiment of the present invention will be described in detail with reference to a drawing. Further, in the following description, the part of the description is omitted about the same operation as the fifth exemplary embodiment.

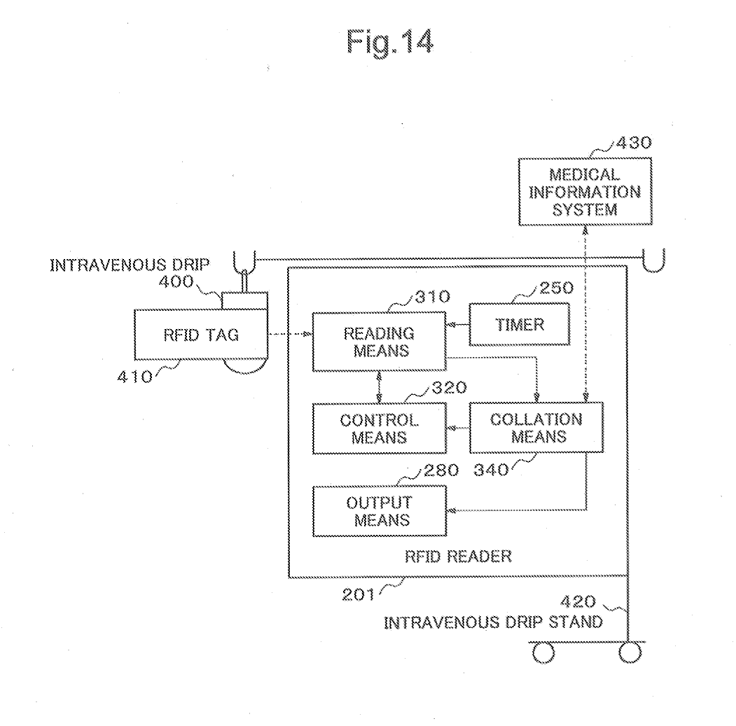

Referring to FIG. 14, the RFID reader 201 of this exemplary embodiment is different from the RFID reader 200 of the fifth exemplary embodiment shown in FIG. 13 in the point that a timer 250 is added.

The time 250 outputs the present time synchronizing with the medical information system 430 using a means which is not illustrated to the reading means 310. The present time synchronizing with the medical information system 430 is that the medical information system 430 and the reading means 310 may acquire the standard time respectively. And the present time synchronizing with the medical information system 430 is that the timer 250 may periodically adjust its own time by getting the time from the medical information system 430. Moreover, the present time synchronizing with the medical information system 430 is that the timer 250 may acquire the time from the medical information system 430 when the timer 250 outputs the present time.

The reading means 310 inputs the present time from the timer 250 and adds it to the detection notification and undetection notification.

The collation means 340 sends the detection notification and undetection notification of the managed RFID tag which has the managed identification information 342 to the medical information system 430.

In a concrete example, when implementation of the intravenous drip 400 completes and a medical staff removes the intravenous drip 400 prescribed to a patient from the intravenous drip stand 420, the reading means 310 detects the undetection of the RFID tag 410 stuck on the intravenous drip 400. Successively, the reading means 310 which detects the undetection of the RFID tag 410 creates the indication of “Detection” and the undetection notification including the identification information 411 and the present time.

Next, the collation means 340 confirms whether the identification information 411 of the RFID tag 410 included in the undetection notification matches with any one of the detection identification information 344 stored in the detection identification information table 343 or not, and sends it to the medical information system 430 when it is matched with the detection identification information 344.

When the reading means 310 detects the detection of the RFID tag 410, the operation is similar.

The collation means 340 may add the identification information 411 of the RFID tag 410 stuck on the intravenous drip 400 and the identification information of the patient who uses the RFID reader 201 to the undetection notification and detection notification which are sent to the medical information system 430.

And the collation means 340 may send the undetection notification and detection notification together when the undetection number 122 matches with the undetection threshold value 124, that is, the case that all of the managed RFID tags corresponding to the managed identification information 342 held in the managed identification information table 341 are detected and undetected.

The first effect in this exemplary embodiment mentioned above is the point to enable to obtain the information about the time that is needed for implementing the intravenous drip 400 prescribed to the patient. The reason is because the RFID reader of this exemplary embodiment sends the undetection notification and detection notification with the present time to the medical information system 430.

The second effect in this exemplary embodiment mentioned above is the point to reduce the time and effort for recording the complementation of the intravenous drip implementation even for the case that the implemented number of the intravenous drips is added. The reason is because the RFID reader of this exemplary embodiment sends the undetection notification and the detection notifications together when all the managed RFID tags are detected and undetected.

Next, the seventh exemplary embodiment of the present invention will be described in detail with reference to a drawing. Further, in the following description, the part of the description is omitted about the same operation as the fifth exemplary embodiment.

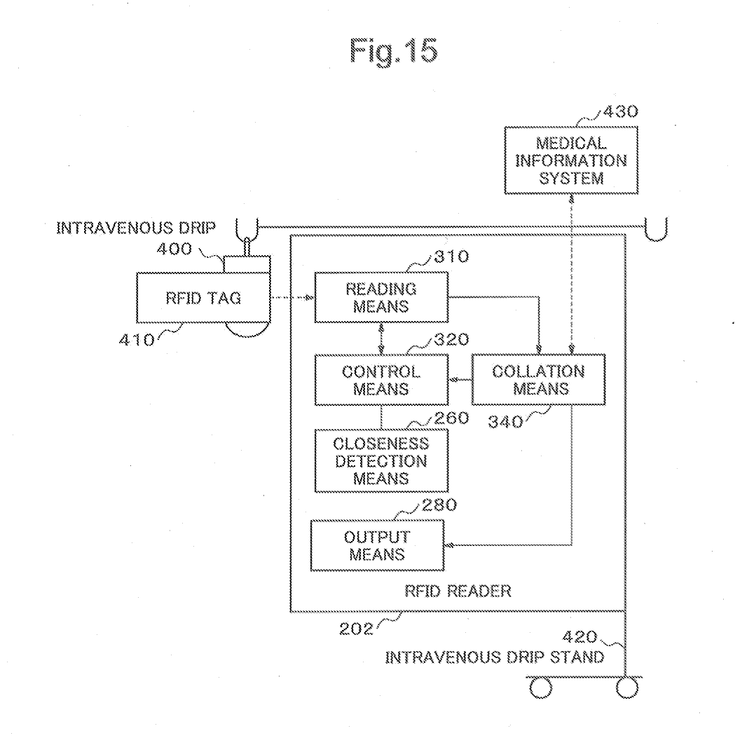

Referring to FIG. 15, the RFID reader 202 of this exemplary embodiment is different from the RFID reader 200 of the fifth exemplary embodiment shown in FIG. 13 in the matter that a closeness detection means 260 is added.

The closeness detection means 260 oscillates the supersonic, for example, and detects the closeness of an object (including a medical staff) based on the reflection of this ultrasonic.

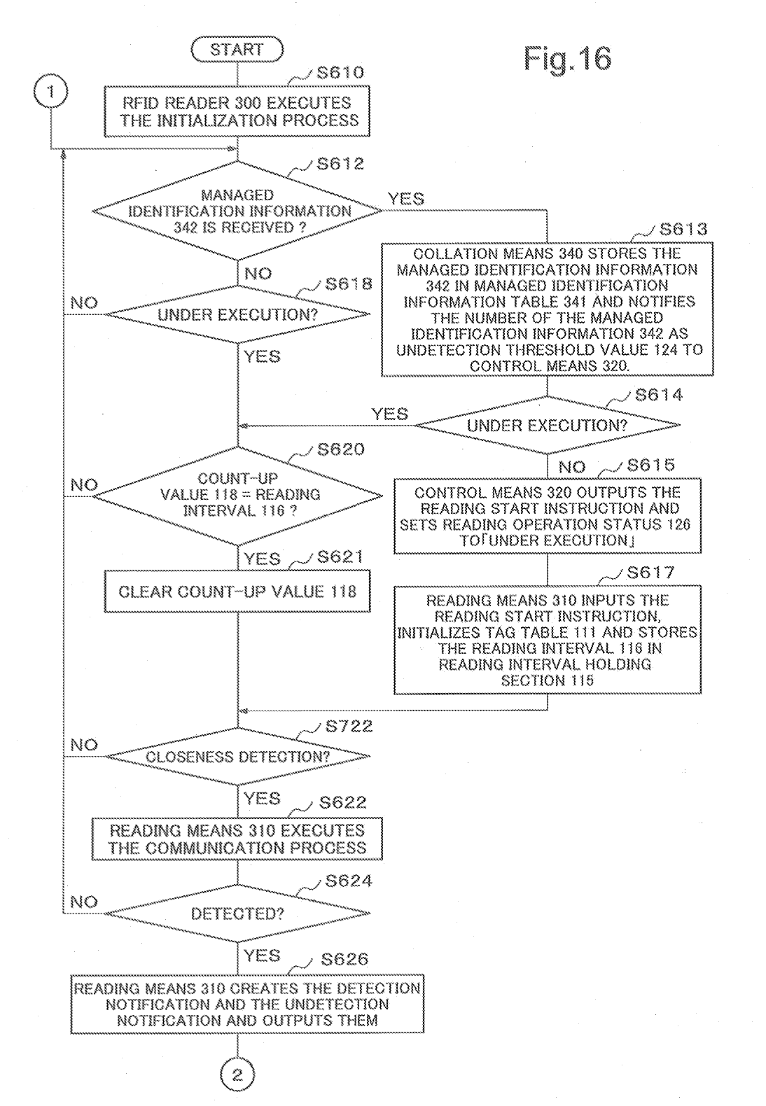

FIG. 16 is the part of the flowchart showing operation of this exemplary embodiment, and it is different from the flowchart showing operation of the fifth exemplary embodiment shown in FIG. 11 in adding Step S722.

In the operation of this exemplary embodiment, it proceeds to the processing of Step S722 next to Step S617. And in the operation of this exemplary embodiment, it proceeds to the processing of Step S722 next to Step S621 in the same way.

In Step S722, the closeness detection means 260 confirms whether the object is close or not (Step S722), and proceeds to the processing of Step S622 when the object is close (YES in Step S722). And when the object is not close (NO in Step S722), the closeness detection means 260 returns to the processing of Step S612.

The effect in this exemplary embodiment mentioned above is to the point to reduce the power consumption more. The reason is because the RFID reader of this exemplary embodiment skips the execution of the communication processing and suppresses the radio radiation when the object is not close.

Next, the eighth exemplary embodiment of the present invention will be described in detail with reference to a drawing. Further, in the following description, the part of the description is omitted about the same operation as the fifth exemplary embodiment.

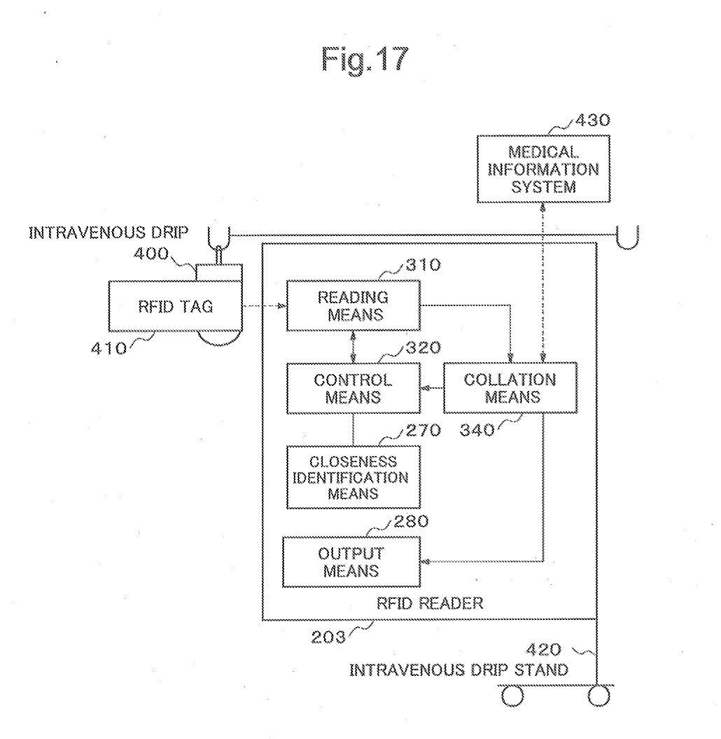

Referring to FIG. 17, the RFID reader 203 of this exemplary embodiment is different from the RFID reader 200 of the fifth exemplary embodiment shown in FIG. 13, in adding a closeness identification means 270.

The closeness identification means 270 receives the notification which a medical staff that has the predetermined identification information approaches and leaves the RFID reader 203 from the medical information system 430, for example. The medical information system 430 detects the closeness and isolation for the RFID reader 203 of the medical staff having the predetermined identification information based on a means (not illustrated) which detects the position of the wireless LAN tag which is not illustrated and haven by the medical staff, for example. The predetermined identification information is the identification information indicating the charge for implementing the intravenous drip 400 prescribed for the patient, for example.

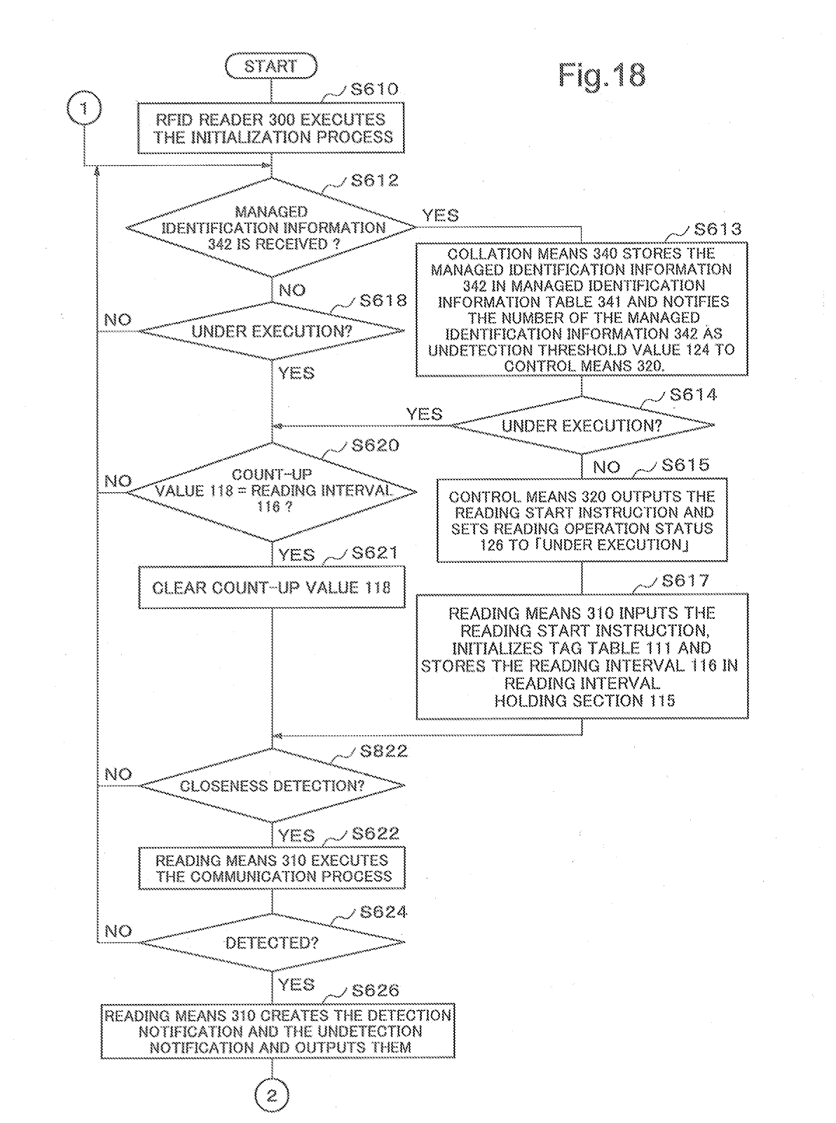

FIG. 18 is the part of the flowchart showing operation of this exemplary embodiment, and it is different from the flowchart showing operation of the fifth exemplary embodiment shown in FIG. 11, in adding Step S822.

In the operation of this exemplary embodiment, it proceeds to the processing of Step S822 next to Step S617. And in the operation of this exemplary embodiment, it proceeds to the processing of Step S822 next to Step S621 in the same way.

In Step S822, the closeness identification means 270 confirms whether a medical staff having predetermined identification information is close or not (Step S822), and proceeds to the processing of Step S622 when the medical staff having predetermined identification information is close (YES in Step S822). And when a medical staff having predetermined identification information is not close (NO in Step S822), the closeness identification means 270 returns to the processing of Step S612.

The effect in this exemplary embodiment mentioned above is the point to enable to reduce the power consumption more. The reason is because the RFID reader of this exemplary embodiment skips the execution of the communication processing and suppresses the radio radiation when a medical staff having predetermined identification information is not close.

Next, the ninth exemplary embodiment of the present invention will be described in detail with reference to a drawing. Further, in the following description, the part of the description is omitted about the same operation as the fifth exemplary embodiment.

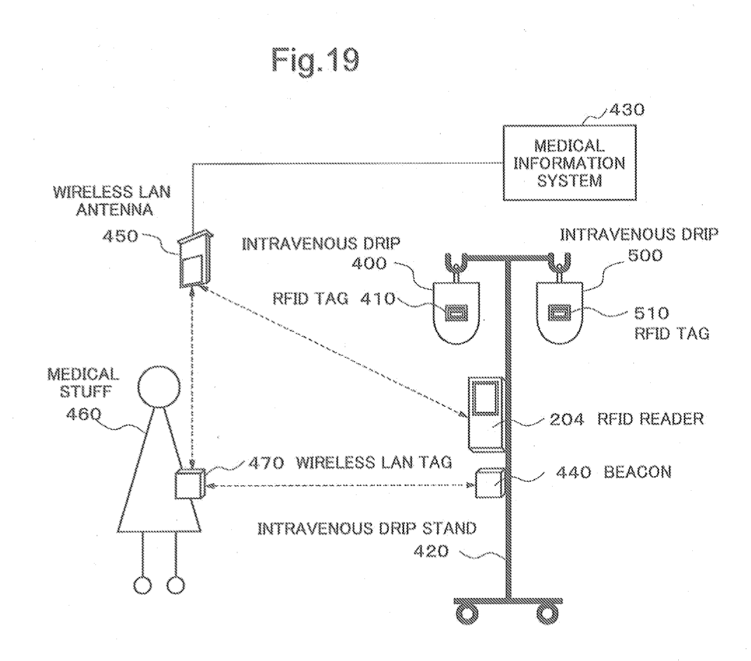

Referring to FIG. 19, the ninth exemplary embodiment of the present invention is comprised the intravenous drip stand 420, the RFID reader 203, the intravenous drip 400, the RFID tag 410 stuck on the intravenous drip 400, an intravenous drip 500, an RFID tag 510 stuck on the intravenous drip 500, the medical information system 430, a beacon 440, a wireless LAN antenna 450, and a wireless LAN tag 470. The wireless LAN tag 470 is carried by medical staff 460.

The RFID reader 203, the medical information system 430, and the wireless LAN tag 470 communicate each other via the wireless LAN antenna 450. The wireless LAN antenna 450 is installed in the ceiling and the wall, for example, in order to perform wireless communication with the RFID reader 203 and the wireless LAN tag 470. As for the frequency band which is used for the wireless communication among the wireless LAN antenna 450, the RFID reader 203, and the wireless LAN tag 470, the 2.4 GHz band which is not so influential to the medical equipment is desirable, for example.

The intravenous drip stand 420 has the structure which enables to mount the RFID reader 203 and the beacon 440 and hang and remove the intravenous drips 400 and 500.

The RFID tags 410, 510 are stuck on the intravenous drips 400, 500 respectively. As for the RFID tags 410, 510, for example, the passive type that has low cost and does not have a battery built-in is desirable. And As for the frequency band for using, 13.56 MHz band which is not easy to be influenced for the water and is not so influential to medical equipment is desirable, for example.

The RFID reader 203 reads the identification information 411 stored in the RFID tags 410, 510 and detects the detection and undetection of the RFID tags 410, 510. And the RFID reader 203 is installed in the intravenous drip stand 420 so that it may be possible to communicate with both of the RFID tag 410 of the intravenous drip 400 and the RFID tag 510 of the intravenous drip 500 hung on the intravenous drip stand 420 and desirable to be able to attach and detach to the intravenous drip stand 420 in order to make the maintenance easy.

Moreover the RFID reader 203 receives the managed identification information 342 and the identification information of the medical staff 460 who carries the wireless LAN tag 470 which closes to the intravenous drip stand 420 from the medical information system 430. The managed identification information 342 is the identification information 411 of the RFID tags 410, 510 which are stuck on the intravenous drips 400, 500 which are prescribed to a patient using the RFID reader 203. And the RFID reader 203 sends the completion record of the intravenous drip processing to the medical information system 430 when the undetection number 122 of the managed RFID tag reaches the undetection threshold value 124, that is, when the intravenous drip prescription to a patient is completed.

In the medical information system 430, an operator records the patient identification information and the identification information 411 of the RFID tags 410, 510 when the RFID tags 410, 510 are stuck on the intravenous drips 400, 500 prescribed to the patient. Next, the medical information system 430 retrieves the RFID reader 203 which the patient is using and sends the identification information 411 of the RFID tags 410, 510. Further, the medical information system 430 holds a corresponding relationship among the identification information of a patient, the intravenous drip stand 420, and the RFID reader 203 installed in the intravenous drip stand 420.

The medical, information system 430 retrieves the RFID reader 203 implemented on the intravenous drip stand 420 and notifies that the medical staff 460 who carries the wireless LAN tag 470 closes to the RFID reader 203 which is retrieved when the identification information of the medical staff 460 who carries the wireless LAN tag 470 and the identification information of the intravenous drip stand 420 described later are received from the wireless LAN tag 470. And the medical information system 430 notifies that the medical staff 460 who carries the wireless LAN tag 470 leaves to the RFID reader 203 when the identification information of the medical staff 460 who carries the wireless LAN tag 470 and the isolation from the intravenous drip stand 420 are received from the wireless LAN tag 470.

And when an end record of intravenous drip processing is received from the RFID reader 203, the medical information system 430 is stored in the inner database.

The beacon 440 is installed in the intravenous drip stand 420 and periodically sends the identification information of the intravenous drip stand 420 using the radio. As for the frequency band which the beacon 440 uses, 125 KHz band which can control the range where the radio waves arrive at in units of 15 cm is desirable, for example. And in order to make the maintenance easy, the beacon 440 is desirable to be able to attach and detach on the intravenous drip stand 420.

The wireless LAN tag 470 is carried by the medical staff 460. When the wireless LAN tag 470 receives the identification information of the intravenous drip stand 420 sent from the beacon 440, the wireless LAN tag 470 notifies the identification information of the intravenous drip stand 420, the identification information of the medical staff 460 who carries the wireless LAN tag 470, and the approach of the medical staff 460 to the intravenous drip stand 420 to the medical information system 430. And when the identification information of the intravenous drip stand 420 which has been received from a beacon 440 in the past time is not received for more than fixed time, the wireless LAN tag 470 notifies the identification information of the intravenous drip stand 420, the identification information of the medical staff 460 who carries the wireless LAN tag 470, and the isolation of the medical staff 460 isolated from the intravenous drip stand 420 to the medical information system 430.

Next, the operation of this exemplary embodiment will be described.

The intravenous drips 400, 500 are respectively prescribed to a certain patient (referred to as a patient A, hereafter) using the intravenous drip stand 420 which is installed the RFID reader 203, and the identification information 411 of the each RFID tags 410, 510 is registered to the medical information system 430 at the same time as the RFID tags 410, 510 are stuck on these intravenous drips 400, 500 respectively. Further, the RFID tags 410, 510 whose identification information 411 are registered to the medical information system 430 can be generally called as managed RFID tags. The medical information system 430 retrieves the RFID reader 203 which the patient A uses and sends the identification information 411 of the each RFID tags 410, 510 to this RFID reader 203. When the RFID reader 203 received the identification information 411 of the management RFID tag, the REID reader 203 stores it as the managed identification information 342. Further, at this timing point, although the reading operation of the reading means 110 stops, the reading means 110 does not start the reading operation because the medical staff 460 does not exist in neighborhood.

Next, when the medical staff 460 brings the intravenous drips 400, 500 to the intravenous drip stand 420, the identification information of the intravenous drip stand 420 sent from the beacon 440 reaches the wireless LAN tag 470. The wireless LAN tag 470 which receives the identification information of the intravenous drip stand 420, notifies the identification information of the medical staff 460, the identification information of the intravenous drip stand 420 received from the beacon 440, and the closeness of the medical staff 460 to the intravenous drip stand 420, to the medical information system 430 via the wireless LAN antenna 450. The medical information system 430 which receives this notification retrieves the RFID reader 203 installed in the intravenous drip stand 420 from the identification information of the intravenous drip stand 420, and notifies the closeness of the medical staff 460 to the intravenous drip stand 420 to the RFID reader 203. The RFID reader 203 which receives the closeness of the medical staff 460 to the intravenous drip stand 420 begins to read using the reading means 110.

Next, when the medical staff 460 hangs the intravenous drip 400 to the intravenous drip stand 420, the RFID reader 203 detects the detection of the RFID tag 410, collates, and stores. Because the identification information 411 of the RFID tag 410 is the managed identification information 342, the RFID reader 203 does not indicate the warning to the output means 280. When the medical staff 460 hangs the intravenous drip 500 to the intravenous drip stand 420, the RFID reader 203 detects the detection of the RFID tag 510, collates, and stores. Because the identification information 411 of the RFID tag 510 is also the managed identification information 342, the RFID reader 203 does not indicate the warning on the output means 280.

Next, when the medical staff 460 leaves the intravenous drip stand 420, the wireless LAN tag 470 does not detect the identification information of the intravenous drip stand 420 which is sent from the beacon 440. Then, the wireless LAN tag 470 notifies the isolation of the medical staff 460 from the intravenous drip stand 420 to the medical information system 430 via the wireless LAN antenna 450. The medical information system 430 which receives this notification notifies the isolation of the medical staff 460 to the RFID reader 203 installed in on the intravenous drip stand 420. The RFID reader 203 which receives this notification stops the reading processing.

Next, when the medical staff 460 approaches to the intravenous drip stand 420 once again, the RFID reader 203 begins to read using the reading means 110 in the same way. After then, when the medical staff 460 removes the intravenous drip 400 and the intravenous drip 500 from the intravenous drip stand 420 successively, the RFID reader 203 detects the undetection of the RFID tag 410 and the RFID tag 510 successively. The RFID reader 203 which detects the undetection of the RFID tag 410 and the RFID tag 510 adds “1” to the undetection number 122 successively, detects that it becomes equal to to the undetection threshold value 124 (“2” which is the number of the managed RFID tag), and suspends the reading processing using the reading means 110.

Although the exemplary embodiment has been described focusing on examples of the application to medical system above, the tag reader of this exemplary embodiment can be also applied to the co-existence of the usage management for the table service at a restaurant using an RFID tag or the equipment at various facilities and the power saving management in this processing, in the same way.

The effect in this exemplary embodiment mentioned above is the point to enable to execute the co-existence for using effectively the acquisition result of the status information of the RFID tag and suppressing effectively the power saving based on this. The reason is because the RFID reader of this exemplary embodiment notifies the undetection information and the detection information adding the present time, and suppresses the radio radiation based on the status information of the managed RFID tag and the closeness/isolation of the medical staff 460.

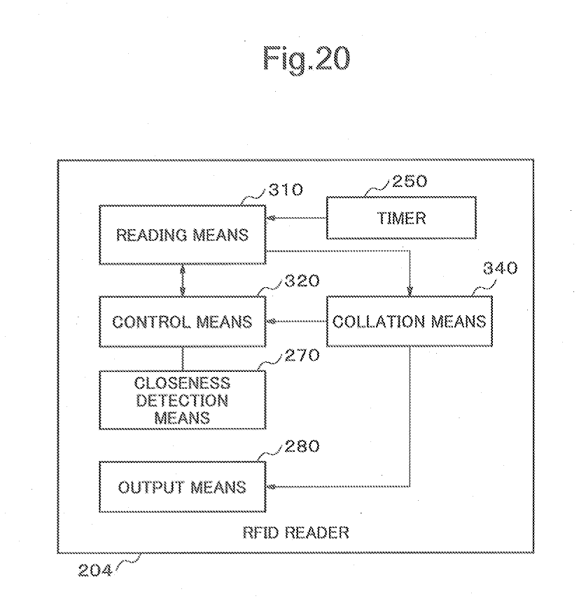

Further, the RFID reader 203 of the ninth exemplary embodiment may be replaced with the RFID reader 204 shown in FIG. 20 equipping the timer 250 that has been described in the sixth exemplary embodiment. The effect can be realized that the time information, which the implementation of the intravenous drip prescribed to a patient like the sixth exemplary embodiment takes, can be obtained based on this construction. The reason is because the RFID reader of this exemplary embodiment can perform the transmission which adds the present time to the undetection notification and the detection notification.

For example, each component described in each exemplary embodiment above mentioned may make a computer execute the predetermined processing using a program.

Each component described in each exemplary embodiment above mentioned does not need to be individually the independent existence. As for each components described in each exemplary embodiment above mentioned, the components, that plural components may be realized in one module, one component may be realized in plural modules, a certain component may be the part of other component, and the part of a certain component may be duplicated the part of other component, is acceptable.

And according to each exemplary embodiment described above, although a plurality of the operations have been described in turn in the form of the flowchart, the described order does not limit the execution order of a plurality of operations. For this reason, when each exemplary embodiment is carried out, the order of a plurality of operations can be changed in the range that does not affect the performance in terms of content.

Moreover, according to each exemplary embodiment described above, a plurality of operations does not limit the execution at the different timing individually. For example, during the execution of a certain operation, other operations may occur and the execution timing of a certain operation and the execution timing of the other operation may be duplicated partially or totally.

Moreover, according to each exemplary embodiment described above, although a certain operation is described as that it gives the opportunities for other operations, the description does not limit all the relation between the certain operation and other operation. For this reason, when each exemplary embodiment is carried out, the relation of a plurality of operations can be changed at the range that does not affect the performance in terms of content. And the concrete description of each operation of each component does not limit each operation of each component. For this reason, when each exemplary embodiment is carried out, each concrete operation of each component may be changed from the views point of function, performance and other characteristics at the range that does not affect the performance of each exemplary embodiment.

Further, each component in each exemplary embodiment described above may be realized by hardware, by software, or by the mix of hardware and software, if possible, depending on the need.

And the physical construction of each component is not limited to description of the above mentioned exemplary embodiment, and it may exist independently, may exist in combination, or may exist in isolation.

While the invention has been particularly shown and described with reference to exemplary embodiment thereof, the invention is not limited to the these embodiments. It will be understood to by those of ordinary skill in the art that various changes in form and details may be made therein without departing from the spirit and scope of the present invention as defined by the claims.

This application is based upon and claims the benefit of priority from Japanese patent application No. 2008-275831, filed on Oct. 27, 2008, the disclosure of which is incorporated herein in its entirety by reference.

### THE AVAILABILITY OF THE INDUSTRY

The present invention can be applied town apparatus which collates an intravenous drip which is prescribe to a patient, a medicine, manufactured drug of transfusion, and so on with a patient by working in cooperation with the system of the electronic clinical chart, and the system which includes these apparatuses. And the present invention can also be applied to the use of inventory management system which manages a stock remaining amount, equipment control in a store building and facilities, the security system, and so on.

1-36. (canceled)

37. A tag reader characterized by comprising:
a reading unit which detects undetection of a tag in communication processing with said tag, and
a control unit which disables execution of said communication processing with said tag when undetection number of said tags is counted and said undetection number reaches predetermined undetection threshold value based on detection of undetection using said reading unit.

38. A tag reader according to claim 37, further comprising:
a sending unit which sends undetection notification including present time to outside responding to detection of undetection using said reading unit.

39. A tag reader according to claim 38, further comprising:
a holding unit which holds said undetection notification and a sending unit which sends said undetection notification together which is held to outside when said undetection number reaches a predetermined undetection threshold value.

40. A tag reader according to claims 37, characterize in that:
said reading unit detects detection of said tag in communication processing for said tag,
said control unit subtract one from said undetection number based on detection of detection using said reading unit.

41. A tag reader according to claim 40, further comprising:
a sending unit which sends detection notification including present time to outside responding to detection of detection using said reading unit.

42. A tag reader according to claim 41, further comprising:
a holding unit which holds said detection notification and a sending unit which sends said detection notification together which is held to outside when said undetection number reaches a predetermined undetection threshold value.

43. A tag reader according to claims 37, characterized in that:
said control unit holds history records of identification information of tag whose undetection said reading unit detects, and counts undetection number of said tags based on whether identification information of tags whose undetection said reading unit detects matches with any one of identification information included in said history records.

44. A tag reader according to claims 37, further comprising:
a collation unit which detects undetection of a managed tag when identification information of tag whose undetection said reading unit detects is a identification information of predetermined said managed tag, and
said control unit counts undetection number of said tags based on detection of undetection of said managed tags by said collation unit.

45. A tag reader according to claim 44, characterizes in that:
said collation unit detects detection of said managed tag when identification information of tag whose detection said reading unit detects is identification information of said managed tag,
said control unit subtracts one from said undetection number based on detection of detection of said managed tags using said collation unit.

46. A tag reader according to claim 44, characterized in that:
an identification information of said managed tags are identification information of tags stuck on respective intravenous drips prescribed to a specific patient.

47. A tag reader according to claims 37, further comprising:
a closeness detection unit which detects closeness and isolation of an object, and
said control unit enables or disables execution said communication processing with sais tag based on detection of closeness and isolation of said object using said closeness detection unit.

48. A tag reader according to claims 37, further comprising:
a closeness detection unit which detects closeness and isolation of an object based on identification information which said object has, and
said control unit enables or disables execution said communication processing with said tag based on detection of closeness and isolation of said object using said closeness detection unit.

49. A tag reader control method, characterized by comprising:
detecting undetection of said tag in communication processing with said tag,
counting undetection of said tags, and
disabling execution said communication processing with said tag when said undetection number reaches predetermined undetection threshold value based on said undetection.

50. A tag reader control method according to claim 49, further comprising:
sending undetection notification including present time to outside responding to detection of said undetection.

51. A tag reader control method according to claim 50, further comprising:
holding said undetection notification and
sending said undetection notification together which is held to outside when said undetection number reaches predetermined undetection threshold value.

52. A tag reader control method according to claim 49 further comprising:
detecting detection of said tag in communication processing with said tag and
subtracting one from said undetection number based on detection of said detection.

53. A tag reader control method according to claim 52, further comprising:
sending detection notification including present time to outside responding to detection of said detection.

54. A tag reader control method according to claim 53, further comprising:
holding said detection notification and
sending said detection notification together which is held to outside when said undetection number reaches predetermined undetection threshold value.

55. A tag reader control method according to claims 49, further comprising:
holding history records of identification information of tag whose undetection is detected and
counting undetection number of said tag based on whether identification information of tag whose undetection is detected matches with any one of identification information included in said history records.

56. A recording medium which records a tag reader control program, characterized by making a computer work as:
a process for detecting undetection of said tag in communication processing with said tag,
a process for counting undetection number of said tag, and
a process for disabling execution said communication processing with said tag when said undetection number reaches predetermined undetection threshold value based on detection of said undetection.
